(19) United States
(12) Patent Application Publication
(10) Pub. No.: US 2006/0135156 A1
(43) Pub. Date: Jun. 22, 2006

(54) Method and system for providing sponsored events for a mobile terminal

(75) Inventors: Chand Malu, Vantaa (FI); Murali Krishna Punaganti Venkata, Vantaa (FI)

Correspondence Address: FOLEY & LARDNER LLP, 321 NORTH CLARK STREET, SUITE 2800, CHICAGO, IL, 60610-4764, US

(73) Assignee: Nokia Corporation

(21) Appl. No.: 11/018,952

(22) Filed: Dec. 21, 2004

(51) Int. Cl. H04Q 7/20

(52) U.S. Cl. 455/432.3

(57) ABSTRACT

A system and method for providing sponsored content to a user of an electronic device in conjunction with the execution of an event. When an event on an electronic device is initiated, a set of sponsor preferences are checked for information regarding the event. A set of sponsored content based upon the sponsor preferences are obtained, and the sponsored content is transmitted to the user in conjunction with the execution of the event.

### FIELD OF THE INVENTION

The present invention relates generally to events occurring in mobile terminals and other electronic devices. More particularly, the present invention relates to mobile terminals into which various events may be executed by a user of a terminal or generated by a system associated with the terminal.

### BACKGROUND OF THE INVENTION

A wide variety of people send and receive messages in mobile communication networks on a regular basis. For example, in a Global System for Mobile Communications (GSM) network, a short message service is widely used. The short message service permits mobile subscribers to send text messages having a maximum length of 160 characters to another mobile subscriber. In this service, the sender of the short message usually pays for the transmission of the message via a short message service center to the receiver.

Currently, many events in such a terminal are set by the user. For example, meeting reminders, placed phone calls, alarms, to-do items, etc. are all set by the user. Other events are raised by the system. These events include received calls, received messages, etc. Currently, however, there is no mechanism that provides additional information along with these events.

### SUMMARY OF THE INVENTION

The present invention provides a system and method for providing advertising and/or sponsored events in a terminal. The present invention involves the addition of extra information to events when they are raised, such as whenever a user receives a phone call or a text message, when an alarm is raised, when a user creates or modifies a calendar event or contact, or the creation or modification of other events. The advertisement can be customized to specifically relate to the event that has been raised, and the sponsor of the advertisement can be charged for the event instead of the user.

The present invention provides for a number of improvements over conventional systems. Unlike conventional systems, the present invention permits the intelligent matching of an event with a sponsor or advertisement, as well as the intelligent matching of an event along with context and preferences. This permits a user's experience to be enriched by having relevant sponsorship information directly related to the event being performed or received transmitted to the user. The advertisements that a user receives can be suitable for the situation involved, and the user is also capable of receiving a benefit, in the form of free services and air time, from the advertiser. In the case of the advertiser or sponsor, there are also a number of advantages. The advertiser or sponsor, under the present invention, has the ability to tailor its advertisements based upon the context of the user and the application being used. The advertiser is also capable of personalizing event-based advertisements, which could help to encourage a user to opt-in for the designated offerings.

These and other objects, advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is an overview diagram of a system within which the present invention may be implemented;

FIG. 2 is a perspective view of a mobile telephone that can be used in the implementation of the present invention;

FIG. 3 is a is a schematic representation of the telephone circuitry of the mobile telephone of FIG. 2;

FIG. 4 is a representation of the system architecture for the implementation of one embodiment of the present invention;

FIG. 5 is a flow chart showing the process of obtaining and displaying an advertisement according to one embodiment of the present invention;

FIG. 6 is a visualization of an advertisement being displayed in conjunction with the receipt of a message;

FIG. 7 is a visualization of an advertisement being displayed in conjunction with the placement of a telephone call;

FIG. 8 is a visualization of an advertisement being displayed in conjunction with the display of an upcoming appointment; and

FIG. 9 is a visualization of an advertisement being displayed in conjunction with the display of an individual's “to do” list.

### DETAILED DESCRIPTION OF THE PREFERRED EMBODIMENTS

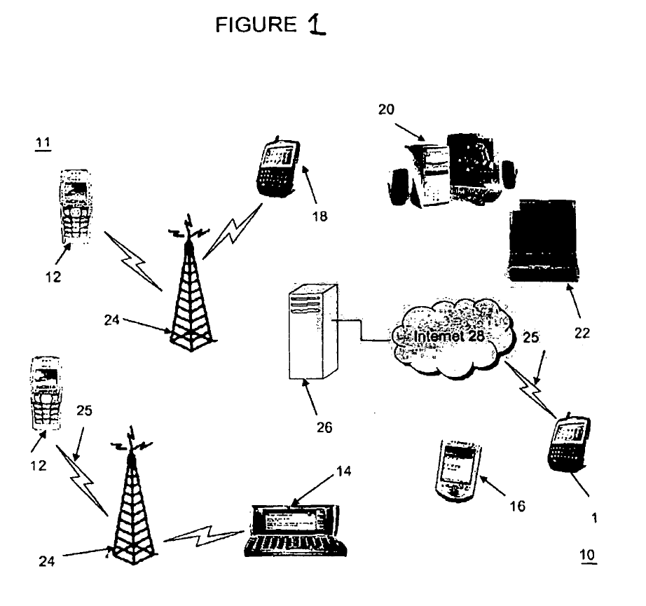

The present invention is directed to a system and method for intelligently providing sponsored events and/or advertisements to electronic devices in conjunction with other events. FIG. 1 shows a system 10 in which the present invention can be utilized, comprising multiple communication devices that can communicate through a network. The system 10 may comprise any combination of wired or wireless networks including, but not limited to, a mobile telephone network, a wireless Local Area Network (LAN), a Bluetooth personal area network, an Ethernet LAN, a token ring LAN, a wide area network, the Internet, etc. The system 10 may include both wired and wireless communication devices.

For exemplification, the system 10 shown in FIG. 1 includes a mobile telephone network 11 and the Internet 28. Connectivity to the Internet 28 may include, but is not limited to, long range wireless connections, short range wireless connections, and various wired connections including, but not limited to, telephone lines, cable lines, power lines, and the like.

The exemplary communication devices of the system 10 may include, but are not limited to, a mobile telephone 12, a combination PDA and mobile telephone 14, a PDA 16, an integrated messaging device (IMD) 18, a desktop computer 20, and a notebook computer 22. The communication devices may be stationary or mobile as when carried by an individual who is moving. The communication devices may also be located in a mode of transportation including, but not limited to, an automobile, a truck, a taxi, a bus, a boat, an airplane, a bicycle, a motorcycle, etc. Some or all of the communication devices may send and receive calls and messages and communicate with service providers through a wireless connection 25 to a base station 24. The base station 24 may be connected to a network server 26 that allows communication between the mobile telephone network 11 and the Internet 28. The system 10 may include additional communication devices and communication devices of different types.

The communication devices may communicate using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc. A communication device may communicate using various media including, but not limited to, radio, infrared, laser, cable connection, and the like.

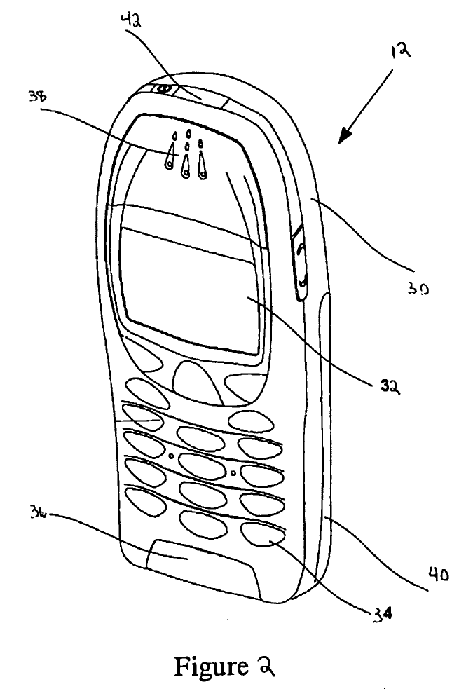

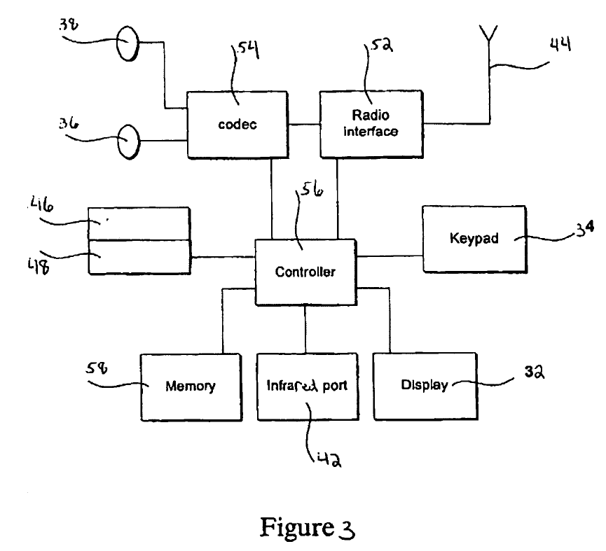

FIGS. 2 and 3 show one representative mobile telephone 12 according to one embodiment of the invention. It should be understood, however, that the present invention is not intended to be limited to one particular type of mobile telephone 12 or other electronic device. The mobile telephone 12 of FIGS. 2 and 3 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment of the invention, a card reader 48, radio interface circuitry 52, coded circuitry 54, a controller 56 and a memory 58. Individual circuits and elements are all of a type well known in the art, for example in the Nokia range of mobile telephones.

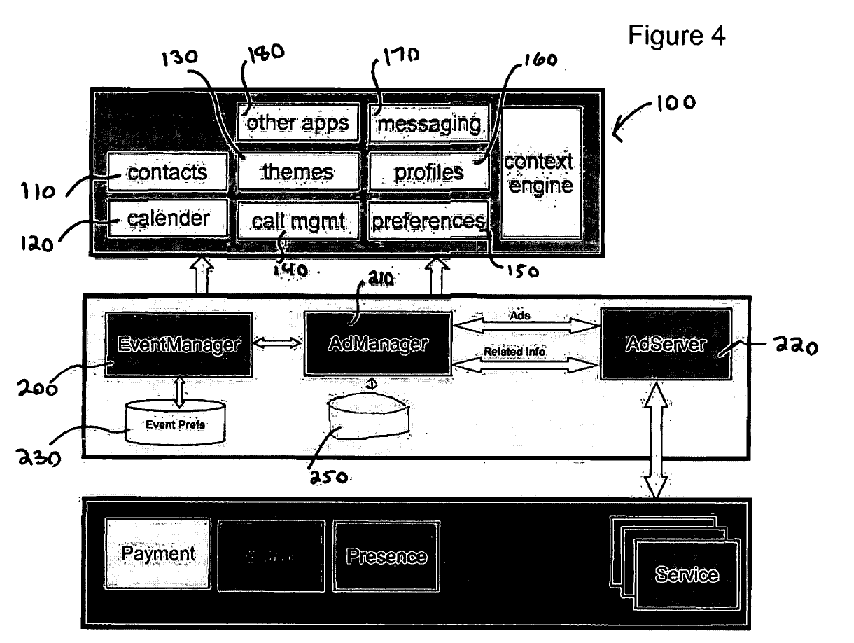

FIG. 4 is a representation of the system architecture for the implementation of one embodiment of the present invention. The base 100 of the system architecture shows several functions and applications that are performed by a wide variety of electronic devices. The applications include contacts 110, a calendar 120, themes 130, a call management system 140, preferences 150, user profiles 160, messaging systems 170, and other applications 180.

The present invention involves the use of an event manager 200, an ad manager 210 and an ad server 220 to add additional information to an event as it is implemented by the electronic device. In one embodiment of the invention, the ad server 220 is located remote from the electronic device, and is accessed as necessary by the ad manager 210. As is shown in FIG. 4, the event manager 200 and the ad manager 210 interact with the base 100 as individual applications are executed. The system architecture also includes a set of event preferences 230 for interaction with the event manager 200 as necessary. The event preferences 230 are used to help tailor advertisements to particular events. The event preferences 230 can be default preferences set by a manufacturer, can be entered with the help of third party software, or can be directly customizable by a user. The system architecture also may include a system cache 250 for locally storing advertisements or other information.

FIG. 4 also discloses several “external” components to the system architecture, including systems for monitoring and controlling the service at issue, as well as payment, billing and other functions.

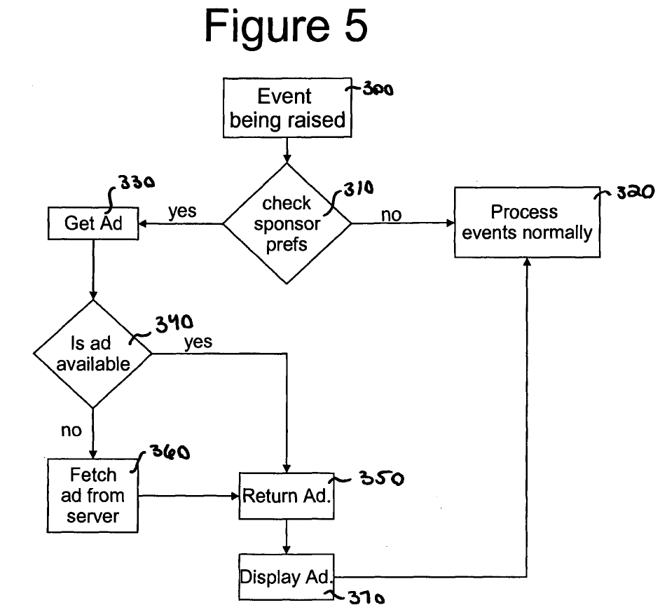

FIG. 5 shows a process through which the present invention may be implemented. At step 300, an event is raised and implemented by the event manager 200. This event could be in the form of a contact being accessed by a user, the sending or receiving of a telephone call, the entering of an appointment on a calendar 120, or a variety of other actions. At step 310, the event manager 200 determines whether the user accepts sponsorship for this particular application. This is used to determine whether an ad or other information should be conveyed to the user in conjunction with the event. This information could be in audio and/or visual form or could be some other sort of data that is provided to the device. If no sponsorship is accepted, then the event is processed normally at step 320.

If an ad or other information is to be conveyed to the user, then at step 330 the event manager 200 instructs the ad manager 210 to obtain an ad or information for use. The ad or information can be selected based upon the settings in the event preferences 230. At step 340, the ad manager 210 checks to see if the ad is immediately available either locally or within the system cache. If the ad or information is immediately available, then at step 350 the ad or information is retrieved for the event manager 200. If the ad or information is not available, then at step 360 the ad manger 210 fetches the appropriate ad or information from the ad server 220, after which the ad or information is presented to the event manager 200 for display or conveyance. At step 370, the ad or information is conveyed as the event is being processed at step 320. It should be noted that the ad or information can take an audio and/or a visual form. All of these steps can be implemented through the use of computer code within a computer program product or products.

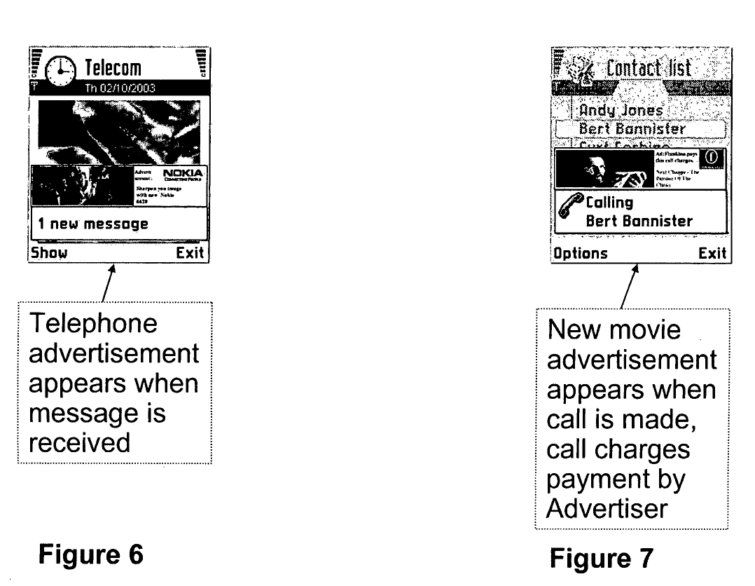

FIGS. 6 and 7 show displays that are implementing one embodiment of the present invention. In FIG. 6, a user is in the process of receiving a message. In this instance, the user has accepted the receipt of an advertisement, and the advertisement therefore appears for a new model of cellular telephone. At the same time, the user is able to receive the message in a normal fashion. In FIG. 7, a call is later made to a person listed in the user's contacts 110. In this instance, an advertisement for a movie appears, and the advertiser pays for the phone call being placed. This provides benefits to both the user and the advertiser, as the user does not have to pay for the phone call while the advertiser is able to advertise as it sees fit in an intelligent manner based upon the event and user preferences 150.

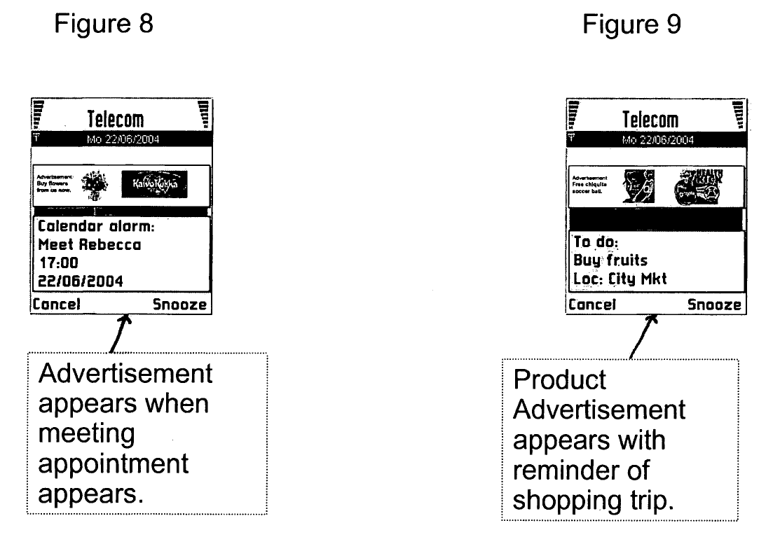

FIGS. 8 and 9 show displays implementing other embodiments of the present invention. In FIG. 8, and advertisement for flowers appears in conjunction with a calendar appointment appearing on the display. In FIG. 9, a product advertisement appears in conjunction with a “to do” list reminder to go grocery shopping.

While several embodiments have been shown and described herein, it should be understood that changes and modifications can be made to the invention without departing from the invention in its broader aspects. For example, but without limitation, the present invention could be incorporated into a wide variety of electronic devices, such as cellular telephones, personal digital assistants, and other devices. Additionally, individual advertisements can be correlated to different events by a variety of methods and based upon a wide variety of criteria. The events may include, but are not limited to the placement of reminders; the creation and opening of “to do” lists; the sounding of a clock alarm; the taking, viewing or transmitting of a digital image, the taking, transmitting or playing of a video clip; the installation of a software application; creating, altering or viewing a user profile; changing themes on a display, converting various parameters; communicating with another device through infrared, BlueTooth or other communication systems; altering a date or location; playing games; or other events. The criteria can also be predetermined or set by the user. Various features of the invention are defined in the following Claims.

What is claimed is:

1. A method of providing sponsored content to a user in conjunction with the execution of an event on an electronic device, comprising the steps of:
having an event initiated for execution on an electronic device;
checking a set of preferences for information regarding the event;
obtaining sponsored content based upon the set of preferences; and
conveying the sponsored content to the user in conjunction with the execution of the event.

2. The method of claim 1, wherein the steps of obtaining a set of sponsored content includes:
determining whether the sponsored content is available on an ad manager; and
if the sponsored content is not available on the ad manager, receiving the sponsored content from a remote server.

3. The method of claim 1, wherein the event is selected from the group consisting of the placing of a telephone call, the receipt of a telephone call, the receipt of a message, the placement of a message, the raising of a calendar event, and the accessing of a contact.

4. The method of claim 1, wherein a sponsor of the sponsored content provides a benefit to the user.

5. The method of claim 1, wherein the sponsored content comprises an advertisement.

6. The method of claim 1, wherein the set of preferences are modifiable by the user within an event manager.

7. The method of claim 1, wherein the set of preferences are modifiable by the user within an ad manager.

8. The method of claim 1, wherein the set of preferences are modifiable by the user within a preference manager.

9. The method of claim 1, further comprising the step of storing information regarding the sponsored content, the information being selected from the group consisting of the time the sponsored content was conveyed, the date the sponsored content was conveyed, the name of an application associated with the sponsored content, and a location where the sponsored content was conveyed.

10. The method of claim 1, wherein the event is initiated by the electronic device based upon a prior instruction by the user.

11. The method of claim 1, wherein the step of having the event initiated for execution includes the step of intercepting the event after the event is generated by an event manager, and wherein an ad manager is used to fetch and convey the sponsored content.

12. A computer program product for providing sponsored content to a user in conjunction with the execution of an event, comprising:
computer code for having an event initiated for execution on an electronic device;
computer code for checking a set of preferences for information regarding the event;
computer code for obtaining sponsored content based upon the set of preferences; and
computer code for conveying the sponsored content to the user in conjunction with the execution of the event.

13. The computer program product of claim 12, wherein the computer code for obtaining a set of sponsored content includes:
computer code for determining whether the sponsored content is available on an ad manager; and
computer code for, if the sponsored content is not available on the ad manager, receiving the sponsored content from a remote server.

14. The computer program product of claim 12, wherein a sponsor of the sponsored content provides a benefit to the user.

15. The computer program product of claim 12, wherein the event is selected from the group consisting of the placing of a telephone call, the receipt of a telephone call, the receipt of a message, the placement of a message, the raising of a calendar event, and the accessing of a contact.

16. An electronic device, comprising:
a processor;
a display for exhibiting information processed by the processor; and
a memory unit operatively connected to the processor, including a computer program product, the computer program product comprising:
computer code for having an event initiated for execution on an electronic device;
computer code for checking a set of preferences for information regarding the event,
computer code for obtaining sponsored content based upon the set of preferences, and
computer code for conveying the sponsored content to the user in conjunction with the execution of the event.

17. The electronic device of claim 16, wherein the computer code for obtaining a set of sponsored content includes:
computer code for determining whether the sponsored content is available on an ad manager; and
computer code for, if the sponsored content is not available on the ad manager, receiving the sponsored content from a remote server.

18. The electronic device of claim 16, wherein the event is selected from the group consisting of the placing of a telephone call, the receipt of a telephone call, the receipt of a message, the placement of a message, the raising of a calendar event, and the accessing of a contact.

19. The electronic device of claim 16, wherein any cost associated with the event is paid by the sponsor of the sponsored content.

20. A module, comprising:
a processor; and
a memory unit operatively connected to the processor, and including a computer program product, the computer program product comprising:
computer code for having an event initiated for execution on an electronic device;
computer code for checking a set of preferences for information regarding the event,
computer code for obtaining sponsored content based upon the set of preferences, and
computer code for conveying the sponsored content to the user in conjunction with the execution of the event.

21. The module of claim 20, wherein the computer code for obtaining a set of sponsored content includes:
computer code for determining whether the sponsored content is available on an ad manager; and
computer code for, if the sponsored content is not available on the ad manager, receiving the sponsored content from a remote server.
